(19) United States
(12) Patent Application Publication
(10) Pub. No.: US 2023/0231957 A1
(43) Pub. Date: Jul. 20, 2023

(54) DISPLAY METHOD AND DISPLAY APPARATUS

(71) Applicant: SEIKO EPSON CORPORATION, Tokyo (JP)

(72) Inventor: Yusuke YAMADA, SHIOJIRI-SHI (JP)

(21) Appl. No.: 18/153,757

(22) Filed: Jan. 12, 2023

(30) Foreign Application Priority Data
Jan. 14, 2022 (JP) 2022-004201

(51) Int. Cl. H04N 1/00

(52) U.S. Cl. CPC H04N 1/00427; H04N 1/00424; H04N 1/00448

(57) ABSTRACT

In a display method, a viewing screen including a first reduced-size image bundle, which is a bundle of one or more first reduced-size images obtained by reducing in size each page of a document file, and the document file is displayed on a display surface; in response to receiving a pinning operation of pinning a page included in the document file, the selected page of the document file is registered as a pinned page; and a controller causes a second reduced-size image bundle, in which each page of the document file is more reduced in size than in the first reduced-size image bundle, to be displayed as an icon on the display surface.

The present application is based on, and claims priority from JP Application Serial Number 2022-004201, filed Jan. 14, 2022, the disclosure of which is hereby incorporated by reference herein in its entirety.

### BACKGROUND

### 1. Technical Field

The present disclosure relates to a display method and a display apparatus.

### 2. Related Art

An apparatus has been known that displays a plurality of thumbnail images arranged as a list in a predetermined order on the display surface and displays a menu icon associated with a desired thumbnail image when the desired thumbnail image is touched and selected.

For example, in JP-A-2021-15470, when, in an image bundle consisting of a plurality of thumbnail images, a thumbnail image or the image bundle is selected, a menu icon associated with the selected thumbnail image or image bundle is displayed at a location where the menu icon does not overlap the image bundle.

However, with a plurality of document files opened, it takes time and energy to search for a page to be viewed from the plurality of document files.

### SUMMARY

An aspect of the present disclosure is a display method including displaying, on a display surface, a viewing screen including a first reduced-size image bundle and a document file, the first reduced-size image bundle being a bundle of one or more first reduced-size images obtained by reducing in size each page of the document file; receiving a pinning operation of pinning a page included in the document file; registering, as a pinned page, the page of the document file selected by the pinning operation; and displaying, as an icon on the display surface, a second reduced-size image bundle in which each page of the document file is more reduced in size than in the first reduced-size image bundle.

Another aspect of the present disclosure is a display apparatus including a controller configured to execute displaying, on a display surface, a first reduced-size image bundle and a document file, the first reduced-size image bundle being a bundle of one or more first reduced-size images obtained by reducing in size each page of the document file; receiving a pinning operation of pinning a page included in the document file; registering, as a pinned page, the page of the document file selected by the pinning operation; and displaying, as an icon on the display surface, a second reduced-size image bundle obtained by reducing in size the first reduced-size image bundle of the document file.

### BRIEF DESCRIPTION OF THE DRAWINGS

FIG. 1 is a diagram illustrating a configuration of a display apparatus.

FIG. 2 is a screen diagram depicting an example of a first thumbnail image bundle.

FIG. 3 is an illustration for explaining a method for generating a bird's-eye view image of a first thumbnail image bundle.

FIG. 4 is an illustration for explaining the method for generating the bird's-eye view image of the first thumbnail image bundle.

FIG. 5 is an illustration for explaining the method for generating the bird's-eye view image of the first thumbnail image bundle.

FIG. 6 is an illustration for explaining the method for generating the bird's-eye view image of the first thumbnail image bundle.

FIG. 7 is a screen diagram depicting an example of a list screen.

FIG. 8 is a screen diagram depicting an example of a viewing screen.

FIG. 9 is a screen diagram depicting an example of a first thumbnail image bundle displayed in a first display area.

FIG. 10 is a screen diagram depicting a menu icon group displayed on a display surface.

FIG. 11 is a screen diagram depicting a pinned icon displayed in a third display area.

FIG. 12 is a screen diagram depicting a touch operation on a second thumbnail image bundle.

FIG. 13 is a screen diagram depicting a pinned screen.

FIG. 14 is a screen diagram depicting a plurality of pinned icons displayed in the third display area.

FIG. 15 is a flowchart illustrating operations of the display apparatus.

FIG. 16 is the flowchart illustrating operations of the display apparatus.

### DESCRIPTION OF EXEMPLARY EMBODIMENTS

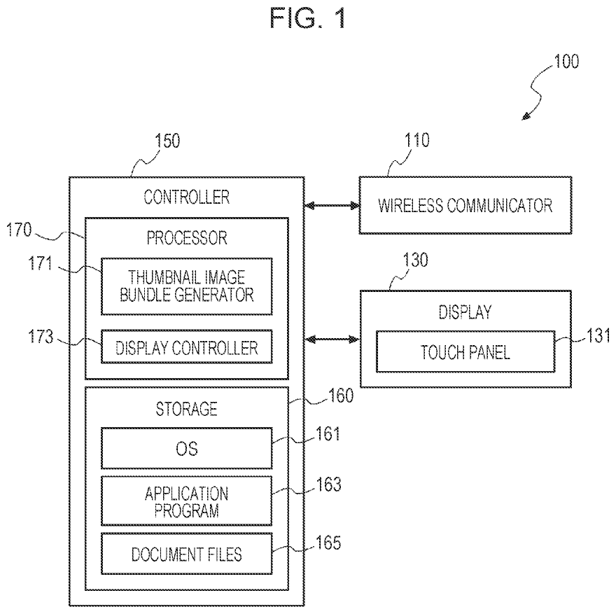

FIG. 1 is a diagram illustrating the configuration of a display apparatus 100.

With reference to FIG. 1, the configuration of the display apparatus 100 will be described.

The display apparatus 100 includes a wireless communicator 110, a display 130, and a controller 150. As the display apparatus 100, for example, a notebook, desktop, or tablet personal computer or a smartphone is used.

The wireless communicator 110, which includes a wireless module and an antenna, communicates with an external device, such as a server device, via a wireless network.

The display 130 includes a touch panel 131 including a display panel and a touch sensor. A liquid crystal panel or an organic electroluminescent (EL) panel, for example, is used as the display panel. The touch sensor detects a touch operation on the display panel. The touch sensor detects a touch location, which is a location of the touch panel 131 at which an indicator, such as an electronic pen or a finger of the user, touches the touch panel 131. The touch sensor outputs an operation signal including the detected touch location to the controller 150. The touch location is represented by the coordinates in a coordinate system set for the display panel.

The controller 150 includes a storage 160 and a processor 170.

The storage 160 includes a volatile semiconductor memory, such as a random-access memory (RAM), and a nonvolatile semiconductor memory, such as a read-only memory (ROM). In addition, when, for example, the display apparatus 100 is a smartphone, the display apparatus 100 may include a secure digital (SD) card as the storage 160. In addition, when the display apparatus 100 is a personal computer, the display apparatus 100 may include an auxiliary storage device, such as a solid state drive (SSD) or a hard disk drive (HDD).

The storage 160 stores an operating system (OS) 161 and an application program 163 that the processor 170 executes. Hereafter, the application program 163 will be referred to as an app 163.

The storage 160 also stores document files 165. Examples of the document file 165 include electronic manuals, electronic books, and documents created by the user. The document file 165 may be a file created by the user executing the app 163 or a file obtained from an external device by the wireless communicator 110.

The processor 170 is constituted by a central processing unit (CPU). Alternatively, the controller 150 may be constituted by a system-on-chip (SoC) on which a CPU, a graphics processing unit (GPU), a communication interface, various sensors, and so on are mounted.

The processor 170 executes the OS 161 and the app 163 to control components of the display apparatus 100.

The controller 150 includes, as functional blocks, a thumbnail image bundle generator 171 and a display controller 173. These functional blocks are blocks conveniently representing functions that are provided by the processor 170 executing the OS 161 and the app 163.

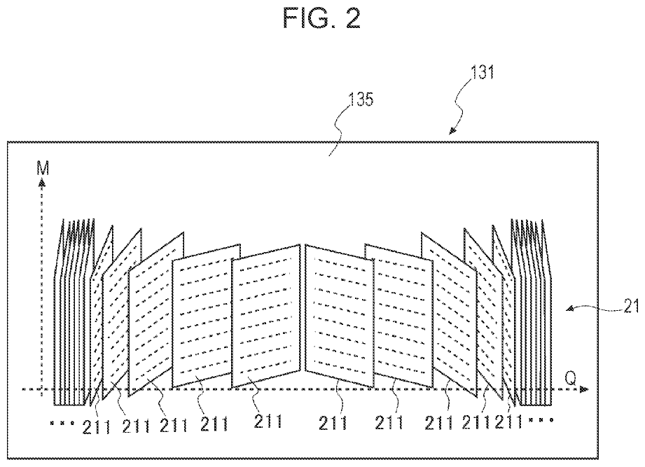

FIG. 2 is a diagram illustrating an exemplary first thumbnail image bundle 21.

The thumbnail image bundle generator 171 reads out the document file 165 from the storage 160 and generates first thumbnail images 211 that are the respective reduced-size images of pages of the read-out document file 165. The first thumbnail images 211 correspond to first reduced-size images. The thumbnail image bundle generator 171 generates a bird's-eye view image of the first thumbnail image bundle 21 based on the first thumbnail image bundle 21 that is a bundle of a plurality of generated first thumbnail images 211. The bird's-eye view image is an image visually recognized by an observer when the observer views the first thumbnail image bundle 21 arranged in a virtual space from any viewpoint in the virtual space. The first thumbnail image bundle 21 corresponds to a first reduced-size image bundle.

The thumbnail image bundle generator 171 arranges a plurality of first thumbnail images 211 in the direction of the first virtual axis Q parallel to the horizontal direction of the display surface 135 of the touch panel 131. The plurality of first thumbnail images 211 may be moved along the first virtual axis Q in response to an operation of the user.

Furthermore, the thumbnail image bundle generator 171 rotates the plurality of first thumbnail images 211 around a second virtual axis M that is parallel to the vertical direction of the display surface 135 and intersects the first virtual axis Q. The thumbnail image bundle generator 171 further rotates the plurality of first thumbnail images 211 around the first virtual axis Q, thereby generating a bird's-eye view image of the first thumbnail image bundle 21.

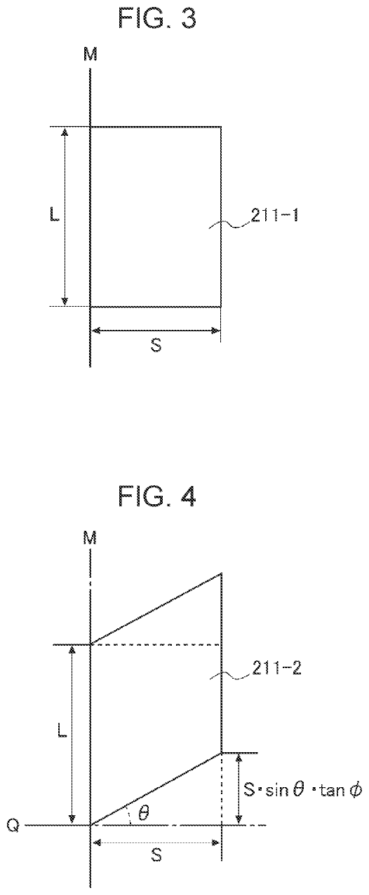

With reference now to FIGS. 3 to 6, a method for generating a bird's-eye view image of the first thumbnail image bundle 21 will be explained.

First, the thumbnail image bundle generator 171 applies a vertical transformation to a first thumbnail image 211-1, which is depicted in FIG. 3 where the first thumbnail image 211-1 is viewed from the front, while inhibiting a change in the width, as illustrated in FIG. 4. Thereby, as illustrated in FIG. 4, a first thumbnail image 211-2 is generated in which the right side of the first thumbnail image 211-1 is shifted relative to the left side by S·sin θ·tan ϕ. The angle ϕ is not illustrated in the figure.

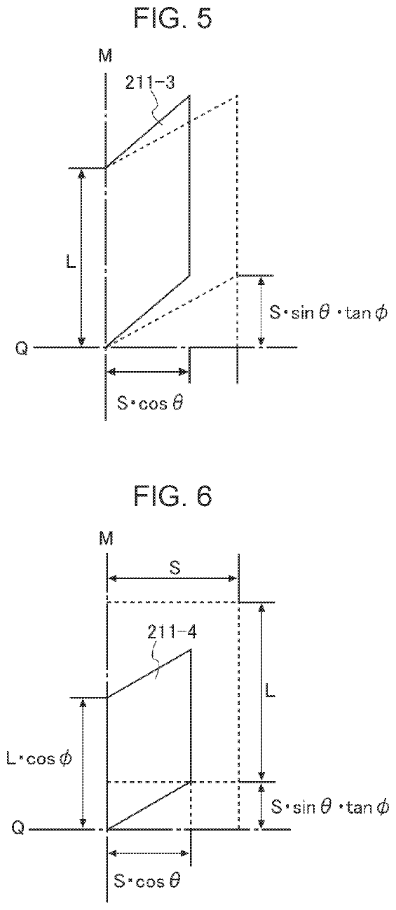

Then, as illustrated in FIG. 5, the thumbnail image bundle generator 171 generates a first thumbnail image 211-3 by reducing the first thumbnail image 211-2 in the horizontal direction by a magnification of cos θ. As a result, the width of the first thumbnail image 211-3 is S·cos θ.

Finally, as illustrated in FIG. 6, the thumbnail image bundle generator 171 generates a first thumbnail image 211-4 in which the first thumbnail image 211-3 is reduced in the vertical direction by a magnification of cos ϕ. As a result, the vertical size of the first thumbnail image 211-4 is L·cos ϕ. Thus, the first thumbnail image 211-4 in which the first thumbnail image 211-1 is rotated by a rotation angle θ around the second virtual axis M and is further rotated around the first virtual axis Q is obtained. In other words, the first thumbnail image 211-4 is obtained by rotating the first thumbnail image 211-1 by the rotation angle θ around the second virtual axis M and providing an oblique top-down view of the first thumbnail image 211-1 at a depression angle ϕ.

The rotation angle θ is set to a rotation angle set in advance with respect to the first virtual axis Q. That is, the rotation angle θ is set to gradually increase as the distance from the center of the display surface 135 increases.

The thumbnail image bundle generator 171 generates bird's-eye view images in the same way for a menu icon group 27 and a second thumbnail image bundle 33, which are described later.

The display controller 173 generates app screens 20 to be displayed on the display surface 135 of the touch panel 131, based on the first thumbnail image bundle 21 generated by the thumbnail image bundle generator 171, the menu icon group 27, and the second thumbnail image bundle 33. The app screens 20 include a list screen 20A, a viewing screen 20B, and a pinned screen 20C. On each of the list screen 20A, the viewing screen 20B, and the pinned screen 20C, a home button 11, with which an operation of returning to the home screen is associated, and a back button 13, with which an operation of returning to the immediately previous screen is associated, are displayed. The back button 13 corresponds to a return button.

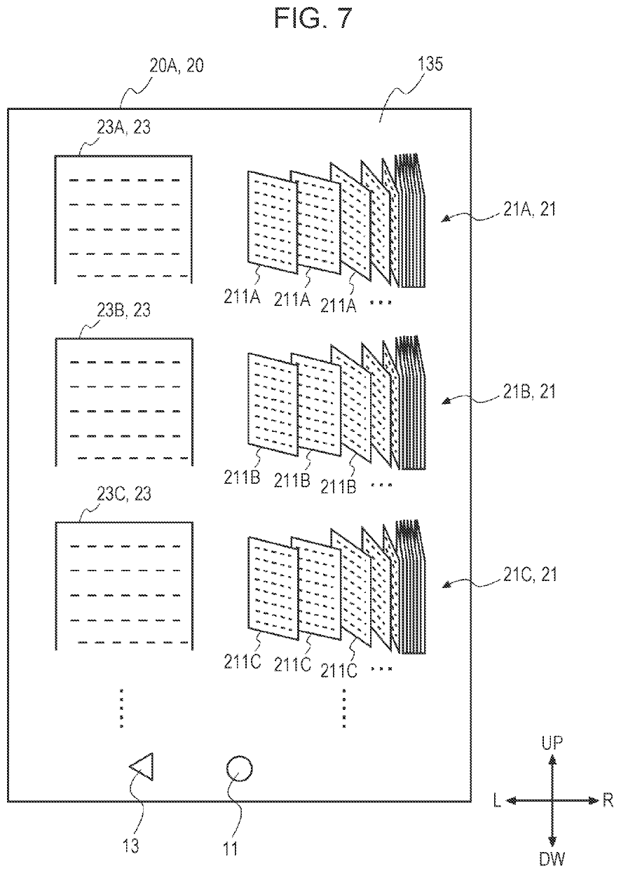

With reference to FIGS. 7 to 14, the app screen 20 will be described.

In FIGS. 7 to 14, the direction to the top of the figure is designated by reference characters UP representing the up direction, the direction to the bottom of the figure is designated by reference characters DW representing the down direction, the direction to the left of the figure is designated by reference character L representing the left direction, and the direction to the right is designated by reference character R representing the right direction.

FIG. 7 is a screen diagram illustrating an example of the list screen 20A.

The list screen 20A is a screen on which a list of the document files 165 stored in the storage 160 is displayed. On the list screen 20A, a combination of the first thumbnail image bundle 21 and a main thumbnail image 23 is displayed for each document file 165. Hereafter, a description will be given assuming that the document files 165, from a document file 165A to a document file 165N, are stored in the storage 160. For the document file 165A, the first thumbnail image bundle 21 is displayed as a first thumbnail image bundle 21A and the main thumbnail image 23 is referred to as a main thumbnail image 23A. The same applies to the documents B to N. In addition, in the present embodiment, a description is given of the case where the first thumbnail image bundle 21A and the main thumbnail image 23A to the first thumbnail image bundle 21N and the main thumbnail image 23N are displayed on the list screen 20A. However, the first thumbnail image bundles 21 and the main thumbnail images 23 based on more document files 165 may be displayed on the list screen 20A.

On the list screen 20A, a combination of the first thumbnail image bundle 21A and the main thumbnail image 23A based on the document file 165A is displayed at a predetermined location.

On the list screen 20A, a combination of the first thumbnail image bundle 21B and the main thumbnail image 23B based on the document file 165B is also displayed. The combination of the first thumbnail image bundle 21B and the main thumbnail image 23B is displayed below and in line with the combination of the first thumbnail image bundle 21A and the main thumbnail image 23A.

On the list screen 20A, a combination of the first thumbnail image bundle 21C and the main thumbnail image 23C based on the document file 165C is also displayed. The combination of the first thumbnail image bundle 21C and the main thumbnail image 23C is displayed below and in line with the combination of the first thumbnail image bundle 21B and the main thumbnail image 23B.

The first thumbnail image bundle 21 is an image group of a plurality of first thumbnail images 211 arranged in the left-right direction. Each of the first thumbnail images 211 included in the first thumbnail image bundle 21 is displayed in a manner in which a bird's-eye view image of the first thumbnail image 211 is taken from a predetermined viewpoint. One first thumbnail image 211 included in the first thumbnail image bundle 21 corresponds to one page of the corresponding document file 165. The first thumbnail image 211 according to the present embodiment is a rectangular image.

The main thumbnail image 23 is a thumbnail image corresponding to a representative page of the document file 165. One example of the representative page is the top page of the document file 165. On the list screen 20A, a portion of the first thumbnail image 211 of a predetermined page may be displayed as the main thumbnail image 23 or the entire first thumbnail image 211 of the predetermined page may be displayed as the main thumbnail image 23.

On the list screen 20A, a selection operation of selecting a combination of the first thumbnail image bundle 21 and the main thumbnail image 23 may be input as a touch operation. In response to the combination being selected on the list screen 20A, the display controller 173 causes the viewing screen 20B regarding the selected document file 165 to be displayed.

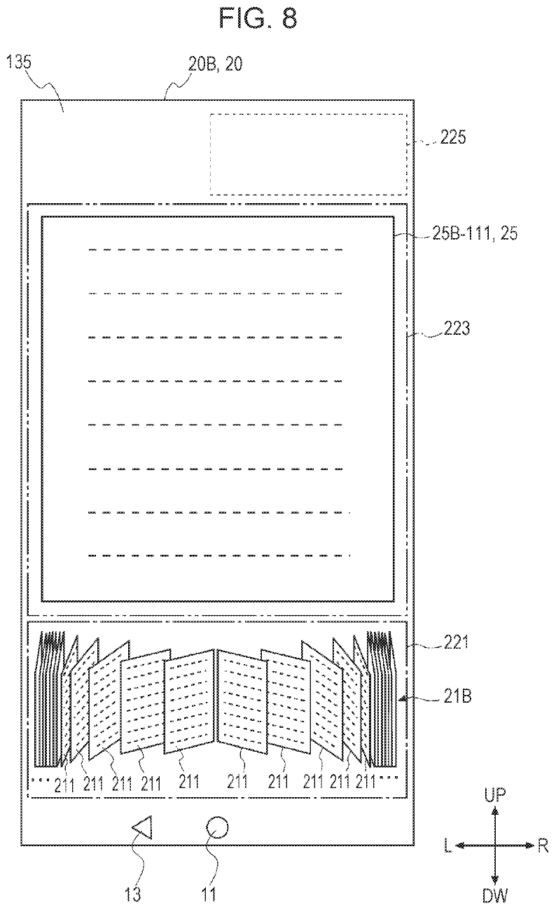

FIG. 8 is a screen diagram depicting an example of the viewing screen 20B.

The viewing screen 20B includes a first display area 221, a second display area 223, and a third display area 225.

The first display area 221 is an area for displaying the first thumbnail image bundle 21 selected on the list screen 20A. When a combination of the main thumbnail image 23 and the first thumbnail image bundle 21 is selected on the list screen 20A, the first thumbnail image bundle 21 included in the selected combination is displayed in the first display area 221.

The display controller 173 changes the display manner of the first thumbnail image bundle 21 in the first display area 221 by a predetermined touch operation, such as a sliding operation, performed using an indicator.

When a rightward sliding operation is performed in the first display area 221, a plurality of first thumbnail images 211 in the first display area 221 move from the left to the right in accordance with the amount of rightward movement of the indicator. When a leftward sliding operation is performed, the plurality of first thumbnail images 211 in the first display area 221 move from the right to the left in accordance with the amount of leftward movement of the indicator.

The second display area 223 is an area for displaying a page image 25 of a page supported by the first thumbnail image 211 selected in the first display area 221. Hereafter, the page image 25 corresponding to the Mth page of the document of the document file 165N will be denoted as a page image 25N-M. M is an integer greater than or equal to one. A page image 25B-111 depicted in FIG. 8 represents a page image 25 corresponding to the 111th page of the document file 165B.

In the second display area 223, a predetermined touch operation, such as a sliding operation, is performed using an indicator, and thereby switching occurs in the displayed page image 25.

When the predetermined touch operation is performed rightward in the second display area 223, the page image 25 of a page previous to the page corresponding to the page image 25 displayed prior to the touch operation is displayed in the second display area 223. When the predetermined touch operation is performed leftward in the second display area 223, the page image 25 of a page following the page corresponding to the page image 25 displayed prior to the touch operation is displayed in the second display area 223.

When, in the state depicted in FIG. 8, a rightward sliding operation is performed in the second display area 223, a page image 25B-110 of a page immediately previous to that of the page image 25B-111 is displayed in the second display area 223. The page image 25B-110 is not depicted in the figure.

In addition, when, in the state depicted in FIG. 8, a leftward sliding operation is performed in the second display area 223, a page image 25B-112 of a page immediately following that of the page image 25B-111 is displayed in the second display area 223. The page image 25B-112 is not depicted in the figure.

Hereafter, the first thumbnail image 211 corresponding to the Mth page of the document of the document file 165N will be denoted as a first thumbnail image 211N-M. For example, a first thumbnail image 211B-98 represents the first thumbnail image 211 corresponding to the 98th page of the document file 165B.

In response to switching in the page image 25 displayed in the second display area 223, the display manner of the first thumbnail image bundle 21 changes in the first display area 221. That is, the first thumbnail image 211 corresponding to the page image 25 after the switching is displayed approximately at the center in the left-right direction of the first display area 221. For example, when the page image 25B-110 is displayed in the second display area 223, a first thumbnail image 211B-110 is displayed approximately at the center in the left-right direction of the first display area 221. In addition, when the page image 25B-112 is displayed in the second display area 223, a first thumbnail image 211B-112 is displayed approximately at the center in the left-right direction of the first display area 221.

In addition, when a sliding operation is performed in the first display area 221 and thus the first thumbnail image 211B-110 is displayed approximately at the center in the left-right direction of the first display area 221, the page image 25B-110 is displayed in the second display area 223. Similarly, when a sliding operation is performed in the first display area 221 and thus the first thumbnail image 211B-112 is displayed approximately at the center in the left-right direction of the first display area 221, the page image 25B-112 is displayed in the second display area 223.

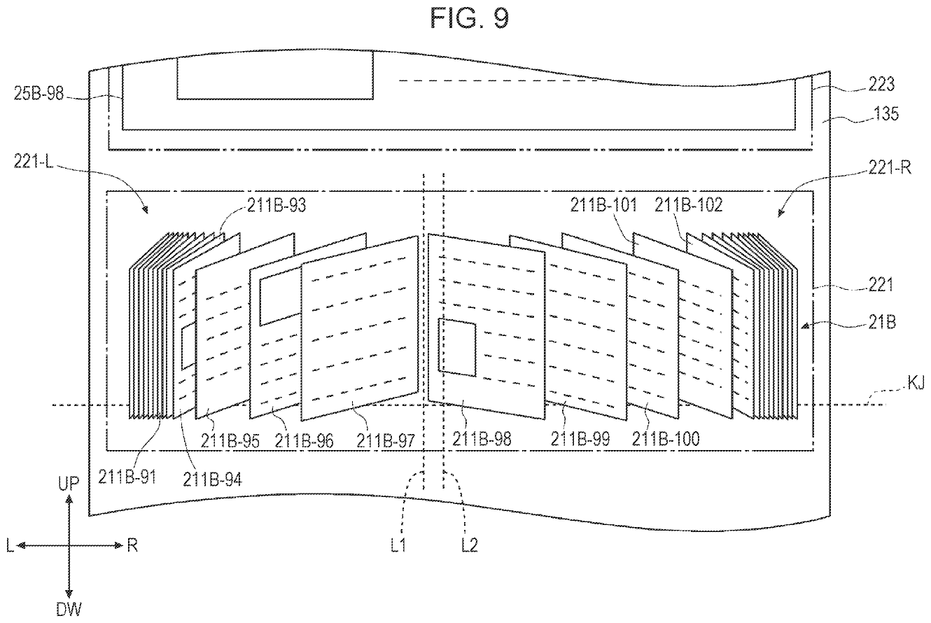

Here, the first thumbnail image bundle 21 displayed in the first display area 221 will be described in more detail. FIG. 9 is a screen diagram depicting an example of the first thumbnail image bundle 21 displayed in the first display area 221. FIG. 9 depicts the display manner of the first display area 221 when the page image 25B-98 is displayed in the second display area 223. The first thumbnail image bundle 21B is displayed in the first display area 221, and the first thumbnail image 211B-98 is displayed approximately at the center in the left-right direction of the first display area 221.

In the first display area 221, the first thumbnail images 211 are displayed in a line on a virtual axis KJ of the display surface 135 of the touch panel 131. The virtual axis KJ is an axis parallel to the left-right direction.

The first display area 221 has a right area 221R and a left area 221L. The right area 221R and the left area 221L are arranged side by side in the left-right direction on either side of a switching line L1. The switching line L1, which is a virtual line located left a center line L2 indicating the center in the left-right direction of the first display area 221, extends in the up-down direction. Like the switching line L1, the center line L2 also extends in the up-down direction.

In FIG. 9, the first thumbnail image 211B-98 is displayed to overlap the center line L2. A first thumbnail image 211B-97, which corresponds to a page previous to the page corresponding to the first thumbnail image 211B-98, is displayed in the left area 221L. The first thumbnail image 211B-98 and a first thumbnail image 211B-99 are displayed in the right area 221R. In the first display area 221, the orientation of the first thumbnail images 211 changes with respect to the switching line L1.

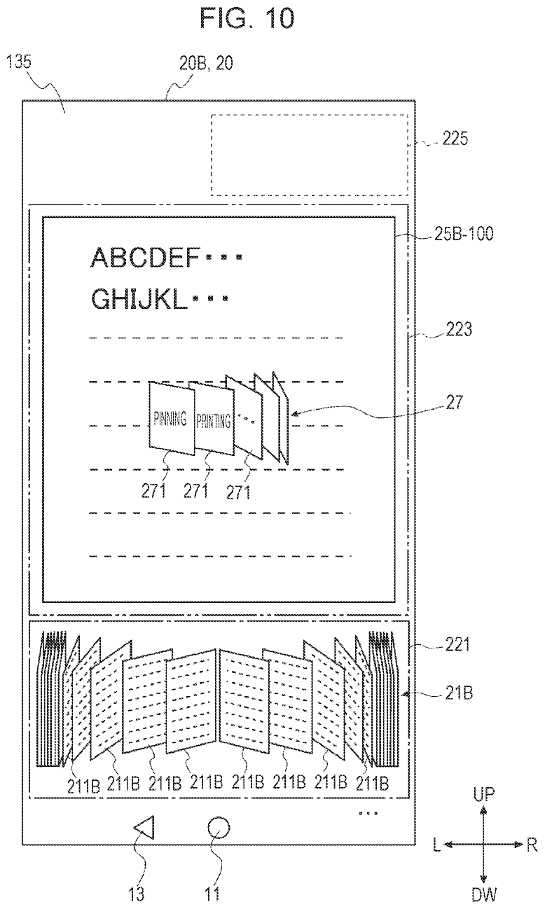

FIG. 10 is a screen diagram depicting the menu icon group 27 displayed on the display surface 135. In response to a predetermined touch operation being detected, the display controller 173 causes the menu icon group 27 to be displayed on the display surface 135. Although FIG. 10 depicts an example in which the menu icon group 27 is displayed in the second display area 223, the display location of the menu icon group 27 is not limited to the second display area 223.

Like the first thumbnail image bundle 21, the menu icon group 27 is an image bundle in which a plurality of menu icons 271 are arranged along the left-right direction of the display surface 135. Operations of pinning, printing, and so on, for example, are associated with the respective menu icons 271. In addition, on each of the menu icons 271, for example, characters, a symbol, or a graphic indicating an operation associated with the menu icon 271 is displayed. FIG. 10 depicts an example in which characters indicating operations associated with the menu icons 271 are displayed.

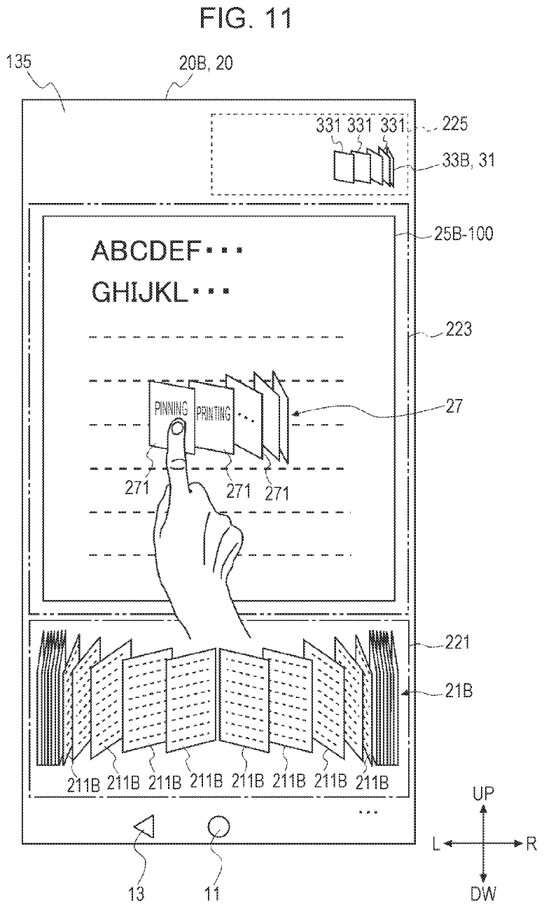

FIG. 11 is a screen diagram depicting a pinned icon 31 displayed in the third display area 225.

The third display area 225 is an area for displaying the pinned icon 31. The pinned icon 31 is an icon indicating the presence of the pinned, or registered, page image 25 of the document file 165. The pinned icon 31 corresponds to an icon.

When the menu icon 271 associated with a pinning operation is selected by a touch operation, the display controller 173 executes a pinning process. Hereafter, a touch operation on the menu icon 271 with which a pinning operation is associated is referred to as a pinning operation.

First, the display controller 173 stores, as a pinned page, the page image 25 of the document file 165 displayed in the second display area 223 and the first thumbnail image bundle 21 displayed in the first display area 221 in the storage 160. At this point, to reserve the storage capacity of the storage 160, the display controller 173 may perform operations of reducing the resolution of the first thumbnail image bundle 21 to be stored in the storage 160 and reducing the resolution of the first thumbnail image bundle 21 that has already been stored.

Next, as the pinning process, the display controller 173 generates the second thumbnail image bundle 33 based on the first thumbnail image bundle 21 in the first display area 221. The second thumbnail image bundle 33 corresponds to a second reduced-size image bundle. The second thumbnail image bundle 33 is a bundle of images that are reduced in size and resolution compared with the first thumbnail image bundle 21. The second thumbnail image bundle 33 includes a plurality of second thumbnail images 331 as depicted in FIG. 11, and the plurality of second thumbnail images 331 are arranged along the horizontal direction of the display surface 135. The display controller 173 causes the generated second thumbnail image bundle 33 to be displayed as the pinned icon 31 in the third display area 225. The second display area 223 and the third display area 225 may be displayed to overlap each other at least partially. On such an occasion, the second thumbnail image bundle 33 is displayed on the front side of the overlap and the page image 25 is displayed on the back side of the overlap.

In the second thumbnail image bundle 33, a plurality of second thumbnail images 331 are arranged as in the first thumbnail image bundle 21 as described with reference to FIGS. 3 to 6. That is, the second thumbnail image bundle 33 is arranged on the first virtual axis Q, the plurality of second thumbnail images 331 are configured to rotate around the second virtual axis M intersecting the first virtual axis Q and furthermore to rotate around the first virtual axis Q. In addition, like the first thumbnail image 211, the second thumbnail image 331 may be moved along the first virtual axis Q in response to an operation of the user.

When a sliding operation is performed as on the first thumbnail image bundle 21, the plurality of second thumbnail images 331 move from the left to the right in accordance with the amount of rightward movement of the sliding operation. In accordance with the amount of movement of the received sliding operation, the display controller 173 moves the second thumbnail images 331 selected by the sliding operation from the left to the right. Likewise, when a leftward sliding operation is performed, the plurality of second thumbnail image 331 move from the right to the left in accordance with the amount of leftward movement of the sliding operation. In accordance with the amount of movement of the received sliding operation, the display controller 173 moves the second thumbnail image 331 selected by the sliding operation from the right to the left.

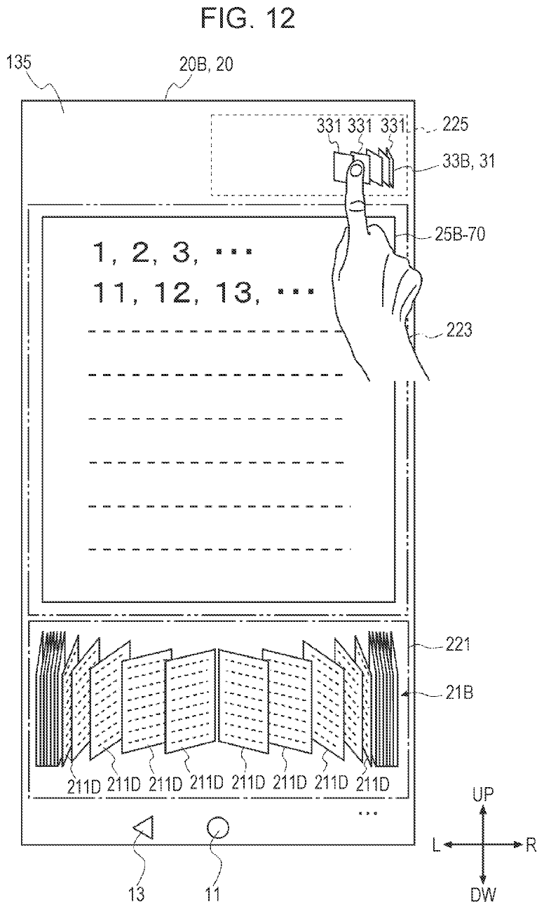

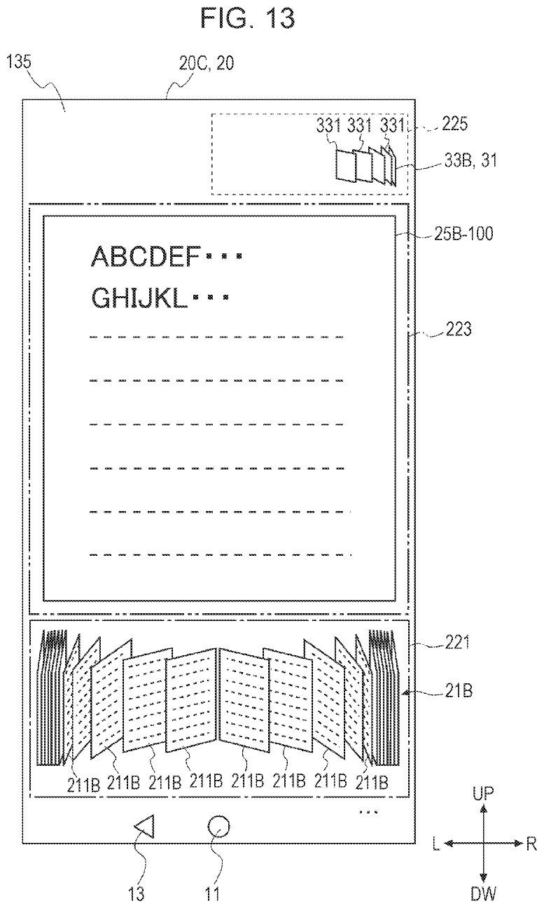

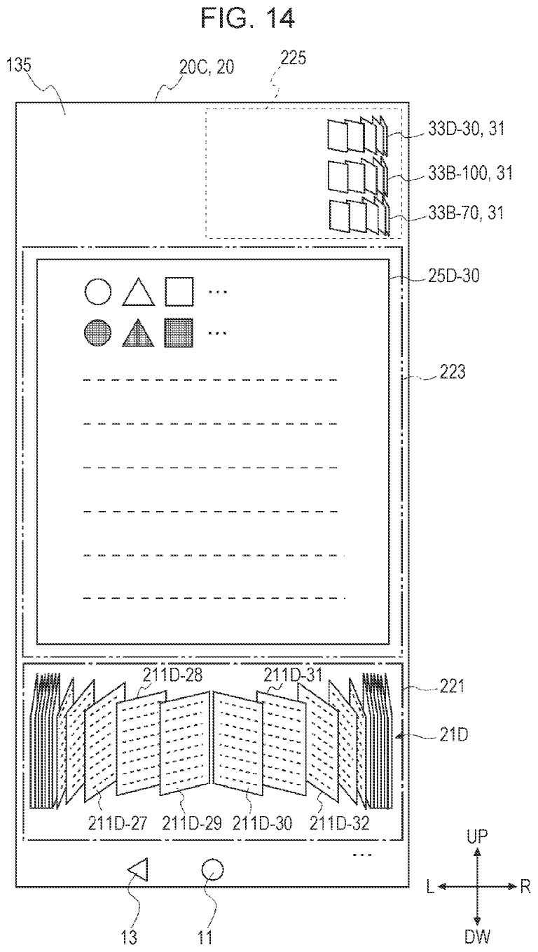

FIG. 12 is a screen diagram depicting a touch operation on the second thumbnail image bundle 33B. In addition, FIG. 13 is a screen diagram depicting the pinned screen 20C.

In the second display area 223 at a time point when the pinning operation depicted in FIG. 11 is performed, a page image 25B-100 of the 100th page of the document file 165B is displayed. That is, the page image 25B-100 on the 100th page of the document file 165B is registered, and the second thumbnail image bundle 33B of the document file 165B is displayed as the pinned icon 31.

Then, assume that, as depicted in FIG. 12, a page image 25B-70 of the 70th page of the document file 165B is displayed in the second display area 223 by a sliding operation of the user. Then, when the second thumbnail image bundle 33B is selected by a touch operation, the display controller 173 causes the pinned screen 20C depicted in FIG. 13 to be displayed. Like the viewing screen 20B, the pinned screen 20C includes the first display area 221, the second display area 223, and the third display area 225. In addition, the viewing screen 20B is, for example, a screen that is displayed by selecting one of the document files 165 from the list screen 20A, whereas the pinned screen 20C is a screen that is displayed by performing a touch operation on the pinned icon 31.

The pinned screen 20C depicted in FIG. 13 is the same screen as the viewing screen 20B displayed when the pinning operation depicted in FIG. 11 has been performed. The background color changes between the pinned screen 20C and the viewing screen 20B to enable the user to recognize whether the screen displayed on the display surface 135 is the pinned screen 20C or the viewing screen 20B.

As depicted in FIG. 13, the page image 25B-100 of the 100th page of the document file 165B is displayed in the second display area 223 of the pinned screen 20C. In addition, the first thumbnail image bundle 21B based on the document file 165B is displayed in the first display area 221. At this point, the display controller 173 causes the first thumbnail image 211B-100 to be displayed to overlap the center line L2.

FIG. 14 is a screen diagram depicting a plurality of pinned icons 31 displayed in the third display area 225.

As depicted in FIG. 14, a plurality of pinned icons 31 may be displayed in the third display area 225. Pinning operations may be performed even for different pages of the same document file 165. A pinning operation may also be performed even when the document file 165 from which the page image 25 displayed in the second display area 223 originates is changed.

That is, a page of the document file 165 different from the document file 165 for which pinning has been performed may be registered as a pinned page.

In the third display area 225 depicted in FIG. 14, an example is demonstrated in which three thumbnail image bundles, the second thumbnail image bundle 33B-70, the second thumbnail image bundle 33B-100, and the second thumbnail image bundle 33D-30, are displayed as the pinned icons 31. In this case, the storage 160 stores, as the pinned pages, the page image 25B-70 of the 70th page of the document file 165B, the page image 25B-100 of the 100th page of the document file 165B, and the first thumbnail image bundle 21B. The storage 160 also stores, as the pinned page, a page image 25D-30 of the 30th page of the document file 165D and a first thumbnail image bundle 21D.

Transitions between screens displayed on the display surface 135 will now be described.

In response to any one of the document files 165 being selected while the list screen 20A is displayed on the display surface 135, the display controller 173 causes the viewing screen 20B for viewing the selected document file 165 to be displayed on the display surface 135.

Then, in response to receiving a pinning operation while the viewing screen 20B is displayed on the display surface 135, the display controller 173 stores, in the storage 160, a page image of the document file displayed in the second display area 223 of the viewing screen 20B. The display controller 173 also stores, in the storage 160, the first thumbnail image bundle 21 displayed in the first display area 221.

Then, when an operation on the back button 13 is received, the display controller 173 returns from the viewing screen 20B to the list screen 20A. Then, in response to another document file 165 being selected, the display controller 173 causes the viewing screen 20B for viewing the selected document file 165 to be displayed on the display surface 135.

In addition, while the viewing screen 20B is displayed on the display surface 135, in response to any one of a plurality of second thumbnail image bundles 33 displayed in the third display area 225 being selected by a touch operation, the display controller 173 causes the pinned screen 20C to be displayed. The display controller 173 causes the first thumbnail image bundle 21 associated with the second thumbnail image bundle 33 on which the touch operation has been performed to be displayed in the first display area 221. The display controller 173 also causes the page image 25 of a page in question of the document file 165 associated with the second thumbnail image bundle 33 on which the touch operation has been performed to be displayed in the second display area 223.

In addition, assume that while the pinned screen 20C is displayed on the display surface 135, another second thumbnail image bundle 33 displayed in the third display area 225 is selected by a touch operation. In this case, the display controller 173 causes the first thumbnail image bundle 21 associated with the other second thumbnail image bundle 33 on which the touch operation has been performed to be displayed in the first display area 221. The display controller 173 also causes the page image 25 of a page in question of the document file 165 associated with the other second thumbnail image bundle 33 on which the touch operation has been performed to be displayed in the second display area 223.

In addition, when the back button 13 is depressed while the pinned screen 20C is displayed on the display surface 135, the display controller 173 causes the viewing screen 20B to be displayed on the display surface 135. Specifically, the viewing screen 20B, on which the page image 25 of the document file 165 has been displayed on the display surface 135 prior to the pinned screen 20C being displayed, to be displayed.

Furthermore, when the back button 13 is depressed while the viewing screen 20B is displayed on the display surface 135, the list screen 20A is displayed on the display surface 135.

In addition, assume that while the list screen 20A is displayed on the display surface 135, the document file 165 different from the document file 165 selected by a pinning operation is selected. In this case, the display controller 173 causes the selected document file 165 to be displayed on the viewing screen 20B.

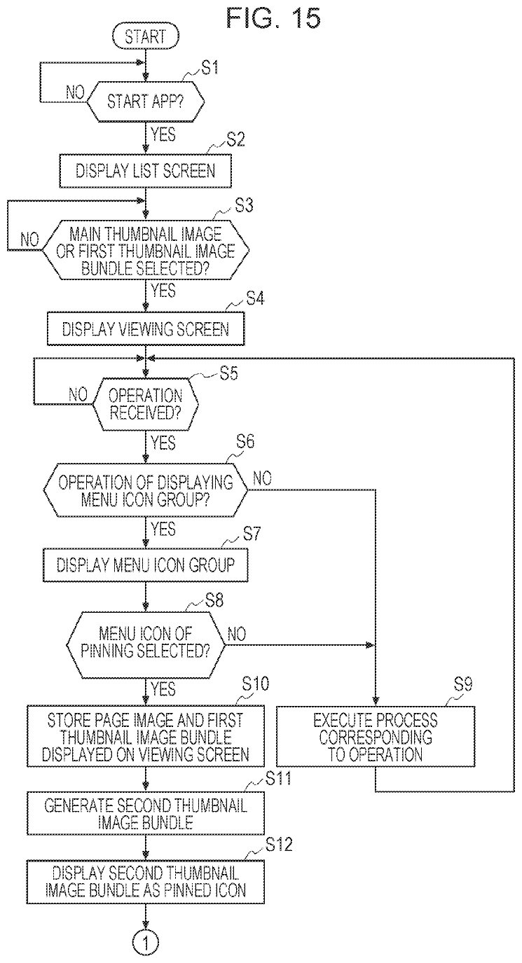

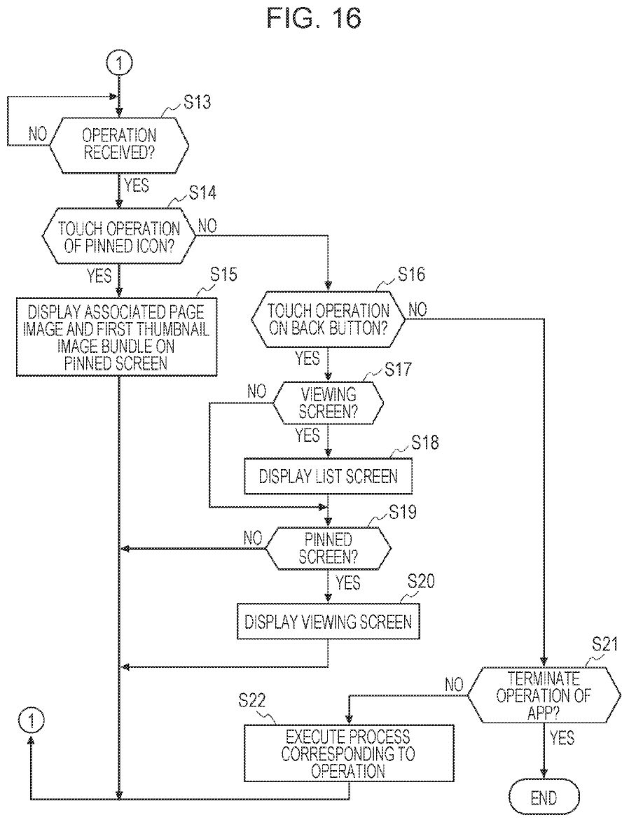

FIGS. 15 and 16 are a flowchart illustrating operations of the controller 150.

With reference to the flowchart illustrated in FIG. 15, the operations of the display apparatus 100 that are performed until the pinned icon 31 is displayed on the viewing screen 20B will now be described.

First, the controller 150 determines whether the controller 150 has received an operation of starting the app 163 (step S1). If the controller 150 has not received the operation of starting the app 163 (No in step S1), the controller 150 stands by until receiving the operation of starting the app 163.

If the controller 150 has received an operation of starting the app 163 (Yes in step S1), the controller 150 causes the list screen 20A to be displayed on the display surface 135 (step S2). On the list screen 20A, a combination of the first thumbnail image bundle 21 and the main thumbnail image 23 is displayed for each document file 165.

Then, the controller 150 determines whether either the first thumbnail image bundle 21 or the main thumbnail image 23 is selected (step S3). If neither the first thumbnail image bundle 21 nor the main thumbnail image 23 is selected (No in step S3), the controller 150 waits until either the first thumbnail image bundle 21 or the main thumbnail image 23 is selected.

If either the first thumbnail image bundle 21 or the main thumbnail image 23 is selected (Yes in step S3), the controller 150 causes the viewing screen 20B to be displayed on the display surface 135 (step S4). On the viewing screen 20B, the first thumbnail image bundle 21 selected on the list screen 20A and the page image 25 of a page supported by the selected first thumbnail image 211 are displayed.

Then, the controller 150 determines whether the controller 150 has received an operation (step S5). If the controller 150 has not received an operation (No in step S5), the controller 150 waits until receiving an operation. Alternatively, if the controller 150 has received an operation (Yes in step S5), the controller 150 determines whether the received operation is an operation of displaying the menu icon group 27 (step S6).

If the controller 150 determines that the received operation is not an operation of causing the menu icon group 27 to be displayed (No in step S6), the controller 150 executes a process corresponding to the received operation (step S9). For example, when the back button 13 is selected by a touch operation, the controller 150 causes the list screen 20A to be displayed on the display surface 135. In addition, when a sliding operation is performed in the first display area 221, the controller 150 moves a plurality of first thumbnail images 211 by an amount of movement corresponding to the amount of the sliding operation in a direction corresponding to the operation direction in which the sliding operation is performed. Thereafter, the controller 150 returns to the determination in step S5.

Alternatively, if the controller 150 determines that the received operation is an operation of displaying the menu icon group 27 (Yes in step S6), the controller 150 causes the menu icon group 27 to be displayed on the viewing screen 20B (step S7).

Then, the controller 150 determines whether the menu icon 271 associated with a pinning operation is selected by a touch operation (step S8). If the menu icon 271 associated with a pinning operation is not selected by a touch operation (No in step S8), the controller 150 executes a process associated with the menu icon 271 selected by the touch operation (step S9). For example, when the menu icon 271 of printing is selected, the controller 150 instructs a printer driver (not illustrated) to generate print data based on the document file 165 displayed on the viewing screen 20B. Thereafter, the controller 150 returns to the determination in step S5.

Alternatively, if the menu icon 271 associated with a pinning operation is selected by a touch operation (Yes in step S8), the controller 150 executes a pinning process.

The controller 150 stores, as a pinned page, the page image 25 of the document file 165 displayed in the second display area 223 and the first thumbnail image bundle 21 displayed in the first display area 221 in the storage 160 (step S10).

Then, as the pinning process, the controller 150 generates the second thumbnail image bundle 33 based on the first thumbnail image bundle 21 in the first display area 221 (step S11). The controller 150 causes the generated second thumbnail image bundle 33 to be displayed as the pinned icon 31 in the third display area 225 (step S12).

With reference to the flowchart illustrated in FIG. 16, the operations of the display apparatus 100 will now be continuously described.

Then, the controller 150 determines whether the controller 150 has received an operation (step S13). If the controller 150 has not received an operation (No in step S13), the controller 150 waits until receiving an operation.

If the controller 150 has received an operation (Yes in step S13), the controller 150 determines whether the received operation is a touch operation on the pinned icon 31 (step S14). If the received operation is a touch operation on the pinned icon 31 (Yes in step S14), the controller 150 causes the pinned screen 20C to be displayed on the display surface 135 (step S15). The controller 150 causes the page image 25 associated with the pinned icon 31, or the second thumbnail image bundle 33, on which the touch operation has been performed to be displayed in the second display area 223 (step S15). The controller 150 also causes the first thumbnail image bundle 21 associated with the second thumbnail image bundle 33 on which the touch operation has been performed to be displayed in the first display area 221 (step S15). Thereafter, the controller 150 returns to the determination in step S13.

Alternatively, if the controller 150 determines that the received operation is not a touch operation on the pinned icon 31 (No in step S14), the controller 150 determines whether the received operation is a touch operation on the back button 13 (step S16).

If the controller 150 determines that the received operation is a touch operation on the back button 13 (Yes in step S16), the controller 150 determines whether the app screen 20 being displayed on the display surface 135 is the viewing screen 20B (step S17).

If the app screen 20 being displayed on the display surface 135 is the viewing screen 20B (Yes in step S17), the controller 150 causes the list screen 20A to be displayed on the display surface 135 (step S18). Alternatively, if the app screen 20 being displayed on the display surface 135 is not the viewing screen 20B (No in step S17), the controller 150 determines whether the app screen 20 being displayed on the display surface 135 is the pinned screen 20C (step S19).

If the app screen 20 being displayed on the display surface 135 is the pinned screen 20C (Yes in step S19), the controller 150 causes the viewing screen 20B displayed prior to displaying the pinned screen 20C to be displayed (step S20).

Alternatively, if the app screen 20 being displayed on the display surface 135 is not the pinned screen 20C (No in step S19), the controller 150 returns to the determination in step S13.

In addition, if the received operation is not a touch operation on the back button 13 (No in step S16), the controller 150 determines whether the received operation is a terminate operation of terminating the app 163 (step S21). If the received operation is not a terminate operation of terminating the app 163 (No in step S21), the controller 150 executes a process corresponding to the received operation (step S22). For example, when the controller 150 receives a sliding operation, the controller 150 changes the display of the display surface 135 in accordance with the received operation. Alternatively, if the received operation is a terminate operation of terminating the app 163 (Yes in step S21), the controller 150 terminates the process flow.

As described above, the controller 150 of the display apparatus 100 executes the process described below.

The controller 150 causes the viewing screen 20B to be displayed on the display surface 135. On the viewing screen 20B, the first thumbnail image bundle 21, which is a bundle of one or more first thumbnail images 211 obtained by reducing in size each page of the document file 165, and the document file 165 are displayed.

In addition, the controller 150 receives a pinning operation of pinning a page included in the document file 165 displayed on the display surface 135 and registers, as a pinned page, the page of the document file 165 selected by the pinning operation.

Then, the controller 150 causes the second thumbnail image bundle 33, in which each page of the document file 165 is more reduced in size than in the first thumbnail image bundle 21, to be displayed as the pinned icon 31 on the display surface 135.

According to this configuration, the page of the document file 165 selected by a pinning operation is registered as a pinned page. Furthermore, the second thumbnail image bundle 33, in which each page of the document file 165 is more reduced in size than in the first thumbnail image bundle 21, is displayed as the pinned icon 31 on the display surface 135. Therefore, selecting the pinned icon 31 enables the page of the document file 165 selected by the pinning operation to be easily displayed on the display surface 135, which may improve the convenience of the user.

The controller 150 causes the list screen 20A, on which a plurality of first thumbnail image bundles 21 based on a plurality of document files 165 are displayed, to be displayed on the display surface 135. In response to receiving a selection operation of selecting one of the plurality of first thumbnail image bundles 21, the controller 150 causes the viewing screen 20B, on which the selected first thumbnail image bundle 21 and the document file 165 from which the first thumbnail image bundle 21 originates are displayed, to be displayed on the display surface 135.

According to this configuration, one first thumbnail image bundle 21 may be selected from the plurality of first thumbnail image bundles 21 displayed on the list screen 20A, and the document file 165 from which the selected first thumbnail image bundle 21 originates may be displayed on the viewing screen 20B.

In response to the second thumbnail image bundle 33 being selected, the controller 150 causes the pinned screen 20C including the page of the document file 165 registered as a pinned page and the first thumbnail image bundle 21 of the document file 165 to be displayed on the display surface 135.

According to this configuration, selecting the second thumbnail image bundle 33 enables the viewing screen 20B including the page of the document file 165 pinned by a pinning operation and the first thumbnail image bundle 21 generated based on the document file 165 to be displayed on the display surface 135.

In response to receiving a pinning operation of pinning a page different from the page registered as the pinned page of the document file 165 or a page of the document file 165 different from the document file 165 of the registered page, the controller 150 registers the different page of the document file 165 or the page of the different document file 165 as a pinned page.

Furthermore, the controller 150 causes the second thumbnail image bundle 33, in which pages of the document file 165 or the different document file 165 are more reduced in size than in the first thumbnail image bundle 21, to be displayed as the pinned icon 31 on the pinned screen 20C. In addition, in response to the second thumbnail image bundle 33 being selected, the controller 150 causes the page of the document file 165 or the different document file 165 from which the selected second thumbnail image bundle 33 originates to be displayed on the viewing screen 20B.

According to this configuration, a different page of the document file 165 one page of which has been registered as a pinned page or a page of the different document file 165 may be registered as a pinned page.

In response to receiving an operation of selecting a return button displayed on the display surface 135 while the pinned screen 20C is displayed on the display surface 135, the controller 150 causes the viewing screen 20B displayed prior to the displaying the pinned screen 20C to be displayed on the display surface 135.

According to this configuration, the screen displayed on the display surface 135 may be returned from the pinned screen 20C to the viewing screen 20B.

In the second thumbnail image bundle 33, a plurality of second thumbnail images included in the second thumbnail image bundle 33 are arranged on the first virtual axis Q, and the plurality of second thumbnail images rotate around the second virtual axis M intersecting the first virtual axis Q and furthermore rotate around the first virtual axis Q.

According to this configuration, an image bundle is configured in which a plurality of second thumbnail images arranged on the first virtual axis Q and rotated around the second virtual axis M intersecting the first virtual axis Q and further rotated around the first virtual axis Q are arranged along the direction of the first virtual axis Q, and thus the second thumbnail image bundle 33 including the plurality of second thumbnail images may be displayed as a bird's-eye view image.

The plurality of second thumbnail images are moved along the first virtual axis Q in response to an operation of a user.

According to this configuration, the plurality of second thumbnail images may be moved along the first virtual axis Q by the operation of the user.

In response to the document file 165 different from the document file 165 selected by a pinning operation being selected from the list screen 20A, the controller 150 causes the selected document file 165 to be displayed on the viewing screen 20B.

According to this configuration, the selected document file 165 may be displayed to be viewed using the viewing screen 20B.

The embodiment described above is a desired embodiment of the present disclosure. However, the present disclosure is not limited to the embodiment described above and various modifications may be made as appropriate without departing from the spirit and scope of the present disclosure.

For example, the functional units of the display apparatus 100 illustrated in FIG. 1 indicate the functional configuration, and their implementation forms are not particularly limited. That is, hardware individually corresponding to function units need not be implemented, and the configuration may be such that the functions of a plurality of functional units are implemented by a single processor executing a program. In addition, some of the functions implemented by software in the embodiment described above may be implemented by hardware. In addition, some of the functions implemented by hardware may be implemented by software. Furthermore, the specific detailed configurations of the other components of the display apparatus 100 may be arbitrarily changed without departing from the spirit and scope of the present disclosure.

In addition, the processing units of the flowchart illustrated in FIGS. 15 and 16 are divided according to the main processing contents to ease understanding of the processing of the display apparatus 100. The present disclosure will not be limited by how the processing units of the flowchart in FIGS. 15 and 16 are divided and what the processing units are named. In addition, according to the processing contents, the processing of the controller 150 may be divided into more processing units or may be divided such that one processing unit includes more processing. In addition, the order of processing of the flowchart mentioned above is not limited to the example illustrated in the figures.

In addition, when the display method is implemented using a computer included in the display apparatus 100 and a computer included in the display apparatus 100, programs to be executed by these computers may be provided in the form of a recording medium. Alternatively, the programs to be executed by these computers may be provided in the form of a transmission medium for transmitting the programs. As the recording medium, a magnetic or optical recording medium or a semiconductor memory device may be used. Specific examples of the recording medium include portable or fixed recording media such as a floppy disk, a hard disk drive (HDD), a compact disc read-only memory (CD-ROM), a digital versatile disc (DVD), a Blu-ray disc, a magneto-optical disc, a flash memory, and a card type recording medium. In addition, the recording medium mentioned above may be a nonvolatile storage device, such as a RAM, ROM, or HDD, which is an internal storage device included in a server device. Blu-ray is a registered trademark.

What is claimed is:

1. A display method comprising:
displaying, on a display surface, a viewing screen including a first reduced-size image bundle and a document file, the first reduced-size image bundle being a bundle of one or more first reduced-size images obtained by reducing in size each page of the document file;
receiving a pinning operation of pinning a page included in the document file;
registering, as a pinned page, the page of the document file selected by the pinning operation; and
displaying, as an icon on the display surface, a second reduced-size image bundle in which each page of the document file is more reduced in size than in the first reduced-size image bundle.

2. The display method according to claim 1, further comprising:
displaying, on the display surface, a list screen including a plurality of first reduced-size image bundles based on a plurality of document files; and
in response to receiving a selection operation of selecting one of the plurality of first reduced-size image bundles, displaying, on the display surface, the viewing screen including the first reduced-size image bundle selected by the selection operation and a document file from which the first reduced-size image bundle originates.

3. The display method according to claim 1, further comprising:
receiving an operation of selecting the second reduced-size image bundle; and
displaying, on the display surface, a pinned screen on which the page of the document file registered as the pinned page and the first reduced-size image bundle generated based on the document file are displayed.

4. The display method according to claim 3, further comprising:
receiving a pinning operation of pinning a page different from the page registered as the pinned page of the document file or a page of a document file different from the document file;
registering, as a pinned page, the different page of the document file or the page of the different document file;
displaying, as an icon on the pinned screen, a second reduced-size image bundle in which each page of the document file or the different document file is more reduced in size than in the first reduced-size image bundle; and
in response to the second reduced-size image bundle being selected, displaying, on the viewing screen, the page of the document file or the different document file from which the selected second reduced-size image bundle originates.

5. The display method according to claim 3, further comprising:
receiving an operation of selecting a return button displayed on the display surface while the pinned screen is displayed; and
displaying, on the display surface, the viewing screen displayed prior to displaying the pinned screen.

6. The display method according to claim 3, wherein
in the second reduced-size image bundle, a plurality of second reduced-size images included in the second reduced-size image bundle are arranged on a first virtual axis, and
the plurality of second reduced-size images rotate around a second virtual axis intersecting the first virtual axis and further rotate around the first virtual axis.

7. The display method according to claim 6, further comprising:
moving the plurality of second reduced-size images along the first virtual axis in response to an operation of a user.

8. The display method according to claim 2, further comprising:
in response to a document file different from the document file selected by the pinning operation being selected from the list screen, displaying the selected document file on the viewing screen.

9. A display apparatus comprising:
a controller configured to execute:
displaying, on a display surface, a first reduced-size image bundle and a document file, the first reduced-size image bundle being a bundle of one or more first reduced-size images obtained by reducing in size each page of the document file;
receiving a pinning operation of pinning a page included in the document file;
registering, as a pinned page, the page of the document file selected by the pinning operation; and
displaying, as an icon on the display surface, a second reduced-size image bundle obtained by reducing in size the first reduced-size image bundle of the document file.
